(19) United States
(12) Patent Application Publication
(10) Pub. No.: US 2026/0086557 A1
(43) Pub. Date: Mar. 26, 2026

(54) INFORMATION PROCESSING APPARATUS, NON-TRANSITORY COMPUTER READABLE-STORAGE MEDIUM STORING A PROGRAM, AND VEHICLE SYSTEM

(71) Applicant: Turing Inc., Tokyo (JP)

(72) Inventors: Issei YAMAMOTO, Tokyo (JP); Yu YAMAGUCHI, Tokyo (JP); Shunsuke AOKI, Tokyo (JP)

(73) Assignee: Turing Inc., Tokyo (JP)

(21) Appl. No.: 19/408,370

(22) Filed: Dec. 4, 2025

Related U.S. Application Data
(63) Continuation of application No. PCT/JP2024/018572, filed on May 21, 2024.

(30) Foreign Application Priority Data
Jun. 8, 2023 (JP) 2023-094498

(51) Int. Cl. G05D 1/243; G05D 1/82; G05D 111/10; G05D 111/20; G05D 111/30

(52) U.S. Cl. CPC G05D 1/243; G05D 1/82; G05D 2111/17; G05D 2111/20; G05D 2111/34

(57) ABSTRACT

An information processing apparatus including a first system having first acquisition circuitry and first output circuitry and a second system having second acquisition circuitry, third acquisition circuitry, and second output circuitry. The first acquisition circuitry may acquire sensor information regarding an environment of a predetermined mobile object by at least one or more sensors installed in the mobile object. Also, the first output circuitry may output auxiliary information for assisting determination of control information for controlling an action of the mobile object. Further, the second acquisition circuitry may acquire partial sensor information from at least one sensor of the one or more sensors, the third acquisition circuitry may acquire the auxiliary information output by the first output circuitry, and the second output circuitry may output control information, using at least part of the partial sensor information or the auxiliary information.

### CROSS-REFERENCE TO RELATED APPLICATIONS

This application is a bypass continuation application of international application No. PCT/JP2024/018572 having an international filing date of May 21, 2024, and designating the United States, the international application being based upon and claiming the benefit of priority from Japanese Patent Application No. 2023-094498 filed on Jun. 8, 2023, the entire contents of each are incorporated herein by reference.

### TECHNICAL FIELD

The present disclosure relates to an information processing apparatus, a non-transitory computer-readable storage medium storing a program, and a vehicle system.

### BACKGROUND

Automotive self-driving technology is one of the technologies that have attracted attention in recent years, and many methods related to self-driving technology have been tried. As one mode thereof, for example, Patent Literature 1 appears to describe a method of applying a machine learning algorithm to decision-making in controlling a self-driving vehicle (see Patent Literature 1, for example).

### CITATION LIST

### Patent Literature

Patent Literature 1: JP 2020-083309 A

### BRIEF SUMMARY

A first aspect of the present disclosure is
an information processing apparatus including a first system and a second system, in which
the first system includes:
first acquisition circuitry configured to acquire sensor information that is information regarding an environment of a predetermined mobile object, the information being acquired by one or more sensors installed in the mobile object; and
first output circuitry configured to output auxiliary information for assisting determination of control information for controlling an action of the mobile object, on the basis of the sensor information,
the second system includes:
second acquisition circuitry configured to acquire partial sensor information from at least one sensor of the one or more sensors installed in the mobile object;
third acquisition circuitry configured to acquire the auxiliary information output by the first output circuitry; and
second output circuitry configured to output the control information, using at least part of the partial sensor information or the auxiliary information.

Also, in the first aspect, the first output circuitry may be configured to output, as the auxiliary information, information including an instruction regarding an action of the mobile object and a reason for determination to issue the instruction.

Further, in the first aspect, an output cycle of the first output circuitry may be configured to be longer than an output cycle of the second output circuitry.

Also, in the first aspect, the first acquisition circuitry may be configured to acquire the sensor information including information acquired from a light sensor including a camera provided to observe directions including front, rear, leftward, and rightward directions of the mobile object, and a sound collecting device installed at an external portion of the mobile object.

Further, in the first aspect, the sound collecting device installed at the external portion of the mobile object may include a plurality of the sound collecting devices disposed on left and right sides of the mobile object.

Also, in the first aspect, the second acquisition circuitry may acquire, as the partial sensor information, information acquired by an imaging apparatus capable of imaging a view ahead of the mobile object in a traveling direction.

Further, in the first aspect, when an action of moving in a different direction from a direction in which the mobile object is currently traveling is planned, the second acquisition circuitry may acquire information regarding the different direction as the partial sensor information.

Also, in the first aspect, the first acquisition circuitry may be configured to further acquire the sensor information including information acquired from a radar related to millimeter waves or from a sonar related to sonar information.

Further, in the first aspect, the second output circuitry may be configured to output the control information including information regarding a predicted path of the mobile object and a special action in control of the mobile object.

Also, in the first aspect, the first output circuitry may be configured to further include trained model managing circuitry, and
the trained model managing circuitry may be configured to perform processing for outputting the auxiliary information, using a general-purpose large language model.

Further, in the first aspect, the auxiliary information may include information regarding an action of the mobile object at a time later than a time of control of the mobile object based on the control information output by the second output circuitry.

Also, in the first aspect, the first system may be connected to a navigation system mounted on the mobile object, and the second system is not necessarily connected to the navigation system mounted on the mobile object.

Further, in the first aspect, in response to the third acquisition circuitry is unable to acquire the auxiliary information, the mobile object may set a severer restriction on an autonomous action of the mobile object than that in a case where the third acquisition circuitry is able to acquire the auxiliary information.

In addition, in the first aspect, the one or more sensors installed in the mobile object may include at least one of an imaging apparatus, a light sensor, a radar, a sonar, a laser radar, an acceleration sensor, a global navigation satellite system (GNSS), a sound collecting device, and an in-vehicle instrument.

A second aspect of the present disclosure is
a program that is executed by an information processing apparatus including a first system and a second system to perform a control process, causing
the first system to carry out:
a first acquisition step of acquiring sensor information that is information regarding an environment of a predetermined mobile object, the information being acquired by one or more sensors installed in the mobile object; and
a first output step of outputting auxiliary information for assisting determination of control information for controlling an action of the mobile object, on the basis of the sensor information, and
the second system to carry out:
a second acquisition step of acquiring partial sensor information from at least one sensor of the one or more sensors installed in the mobile object;
a third acquisition step of acquiring the auxiliary information output by the first output step; and
a second output step of outputting the control information, using at least part of the partial sensor information or the auxiliary information.

Further, in a second aspect, the one or more sensors installed in the mobile object may include at least one of an imaging apparatus, a light sensor, a radar, a sonar, a laser radar, an acceleration sensor, a global navigation satellite system (GNSS), a sound collecting device, and an in-vehicle instrument.

A third aspect of the present disclosure is
a vehicle system including
a vehicle sensor; and
an information processing apparatus including:
a first system and a second system, wherein
   the first system includes:
      first acquisition circuitry configured to acquire sensor information that is information regarding an environment of a predetermined mobile object, the information being acquired by the vehicle sensor installed in the mobile object; and
      first output circuitry configured to output auxiliary information for assisting determination of control information for controlling an action of the mobile object, on a basis of the sensor information,
   the second system includes:
      second acquisition circuitry configured to acquire partial sensor information from the vehicle sensor installed in the mobile object;
      third acquisition circuitry configured to acquire the auxiliary information output by the first output circuitry; and
      second output circuitry configured to output the control information, using at least part of the partial sensor information or the auxiliary information.

Further, in a third aspect, the one or more sensors installed in the mobile object may include at least one of an imaging apparatus, a light sensor, a radar, a sonar, a laser radar, an acceleration sensor, a global navigation satellite system (GNSS), a sound collecting device, and an in-vehicle instrument.

Also, in the third aspect, in response to the third acquisition circuitry being unable to acquire the auxiliary information, the mobile object sets a severer restriction on an autonomous action of the mobile object than that in a case where the third acquisition circuitry is able to acquire the auxiliary information, and
the severer restriction on the autonomous action of the mobile object includes adjusting an automated driving level.

The program that is a mode of the present disclosure is also provided as a program compatible with the information processing apparatus that is a mode of the present disclosure.

### Advantageous Effects of the Disclosure

According to the present disclosure, it is possible to provide a technology for enabling efficient control of a mobile object.

### BRIEF DESCRIPTION OF DRAWINGS

FIG. 1 is a diagram illustrating an example of an information processing system including a vehicle system according to an embodiment of the present disclosure.

FIG. 2 is a diagram illustrating an example of a hardware configuration of the in-vehicle apparatus constituting the information processing system according to an embodiment of the present disclosure.

FIG. 3 is a diagram illustrating an example of a functional configuration of the in-vehicle apparatus constituting the information processing system according to an embodiment of the present disclosure.

FIG. 4 is a diagram for explaining an example flow of a Navigator process among processes to be executed by the in-vehicle apparatus constituting the information processing system according to an embodiment of the present disclosure.

FIG. 5 is a diagram for explaining an example flow of a Driver process among processes to be executed by the in-vehicle apparatus constituting the information processing system according to an embodiment of the present disclosure.

FIG. 6 is a diagram of circuitry used to control process operations, such as implementing the functions of a vehicle system or an in-vehicle apparatus.

### DETAILED DESCRIPTION

In a case where a machine learning technique is applied to controlling of a self-driving vehicle, the amount of information to be processed and the speed of calculation are very important. That is, a training process related to machine learning and a process of applying results of training require large amounts of information and calculation, and take a long time. On the other hand, in controlling a self-driving vehicle, the time during which calculation can be performed is limited, and there is a possibility that the driving of the vehicle will be hindered unless the calculation is effectively performed in an extremely short time.

In this regard, most of the conventional techniques, including Patent Literature 1 mentioned above, merely adopt a machine learning algorithm.

The present disclosure has been made in view of such circumstances, and aims to provide a technology that enables efficient control of a mobile object.

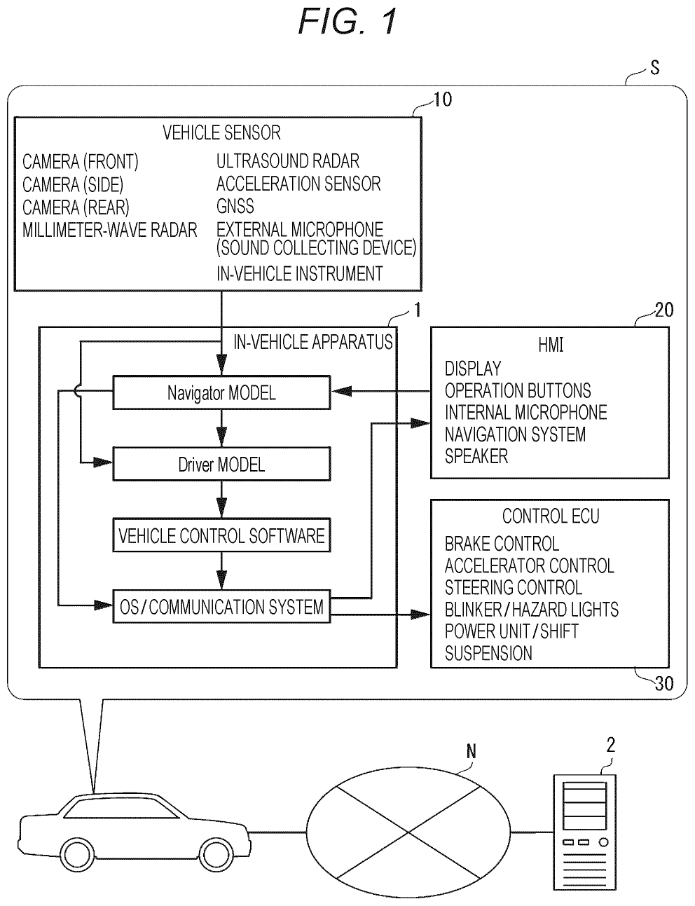

FIG. 1 is a diagram illustrating an example of an information processing system including a vehicle system according to an embodiment of the present disclosure (this information processing system will be hereinafter referred to as “the present system”).

As illustrated in FIG. 1, a vehicle system S according to an embodiment of the present disclosure includes an in-vehicle apparatus 1, a vehicle sensor 10, a human machine interface (HMI) 20, and a control electronic control unit (ECU) 30 (also referred to herein as control electronic control circuitry). Note that these devices and equipment are connected by a predetermined network such as a controller area network (CAN) or Ethernet, for example.

Here, vehicles on which the vehicle system S is mounted may include vehicles and mobile objects of any kinds, such as automobiles powered by electricity, gasoline, or the like, for example.

The vehicle sensor 10 is formed with various sensors for detecting an external environment around the vehicle (an environment that may include other vehicles, pedestrians, structures, and road shapes).

Here, the external environment around the vehicle is an environment that may include traffic participants (such as other vehicles and pedestrians), buildings such as commercial facilities, traffic signs installed on the roadside, road signs formed on the road surface, lane markings, traffic signals, utility poles, guardrails, animals, and fallen objects, for example. Alternatively, the external environment around the vehicle may be an environment that may include information regarding weather and a road surface (a road, a sidewalk, or the like) on which a mobile object can move, and a situation thereof (such as a wet road surface or an uneven surface), for example.

Specifically, as illustrated in FIG. 1, the vehicle sensor 10 includes a camera (a front camera) or a light sensor installed to be able to image a view ahead of the vehicle, cameras (side cameras) or light sensors installed to be able to image views on the sides of the vehicle, a camera (a rear camera) or a light sensor installed to be able to image a view behind the vehicle, a millimeter-wave radar or a radar, an ultrasound radar or a sonar, a light detection and ranging (LiDAR) or a laser radar, an acceleration sensor, a global navigation satellite system (GNSS), an external microphone (a sound collecting device), and an in-vehicle instrument. The above-described light sensors (e.g., photodetectors) are sensitive to light in at least one or more of the visible, near-infrared, and ultraviolet spectrums.

Here, the cameras are formed with cameras using charge coupled devices (CCDs), complementary metal oxide semiconductors (CMOSs), or the like, for example. In the present disclosure, a plurality of cameras in total may be installed on the front, sides, and rear of the vehicle.

Also, the external microphone (sound collecting device) is formed with a general-purpose microphone or the like, and is used to acquire information regarding sound emitted from an object existing outside the vehicle, including sirens of an ambulance or a patrol car, and human voice, for example.

The HMI 20 presents various kinds of information to the driver and a passenger of the vehicle, and receives contents of various input operations. Specifically, as illustrated in FIG. 1, the HMI 20 includes a display, operation buttons, a microphone, various navigation systems, and a speaker, for example.

The control ECU 30 is connected to the in-vehicle apparatus 1, transmits and receives various kinds of information, and performs various kinds of control regarding driving of the vehicle. Specifically, as illustrated in FIG. 1, the control ECU 30 includes individual ECUs that perform various kinds of control, for example, and performs brake control, accelerator control, steering control, control on lights such as blinker lights, and various kinds of control on the power unit, the transmission, the suspension, and the like.

Further, as illustrated in FIG. 1, the present system may include the vehicle system S (in-vehicle apparatus 1) that is managed by the driver or the like of the vehicle, and a server 2 that is managed by a manager or the like of the present system.

The vehicle system S and the server 2 may be connected to each other via a predetermined network N such as the Internet. However, the network N is not an essential element, and, for example, near field communication (NFC), Bluetooth (registered trademark), a local area network (LAN), or the like may be used.

Note that the server 2 acquires various kinds of information regarding driving of the vehicle periodically transmitted from the vehicle system S (in particular, the in-vehicle apparatus 1), and uses the various kinds of information for management.

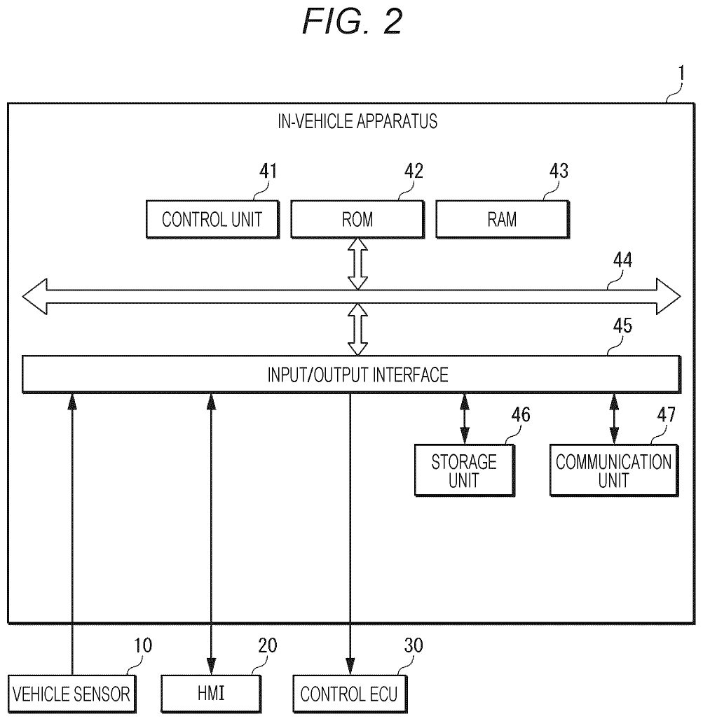

FIG. 2 is a diagram illustrating an example of a hardware configuration of the in-vehicle apparatus constituting the information processing system according to an embodiment of the present disclosure.

As illustrated in FIG. 2, the in-vehicle apparatus 1 includes a control unit 41 (also referred to herein as a controller), a read only memory (ROM) 42, a random access memory (RAM) 43, a bus 44, an input/output interface 45, a storage unit 46 (also referred to herein as a storage), and a communication unit 47 (also referred to herein as a communicator).

The control unit 41 is formed with a microcomputer or the like that includes a CPU, a GPU, a field-programmable gate array (FPGA), and a semiconductor memory. The control unit 41 performs various kinds of processing in accordance with a program recorded in the ROM 42 or a program loaded from the storage unit 46 into the RAM 43.

The RAM 43 stores, as appropriate, information and the like necessary for the control unit 41 to perform various kinds of processing.

The control unit 41, the ROM 42, and the RAM 43 are connected to one another via a bus 44. The input/output interface 45 is also connected to the bus 44. The vehicle sensor 10, the HMI 20, the control ECU 30, the storage unit 46, the communication unit 47, and the like are connected to the input/output interface 45.

The storage unit 46 is formed with a hard disk drive (HDD), a solid state drive (SSD), or the like, and stores various kinds of information. For example, the storage unit 46 stores various programs and the like necessary for execution of various kinds of processing related to the present system.

The communication unit 47 controls communication and the like with other hardware or the like via the network N including the Internet.

Note that the hardware configuration of the server 2 can be basically the same as the hardware configuration of the in-vehicle apparatus 1, and therefore, explanation thereof is not made herein. Such cooperation of various kinds of hardware and various kinds of software enables execution of various kinds of processing in the in-vehicle apparatus 1 and the like as described later.

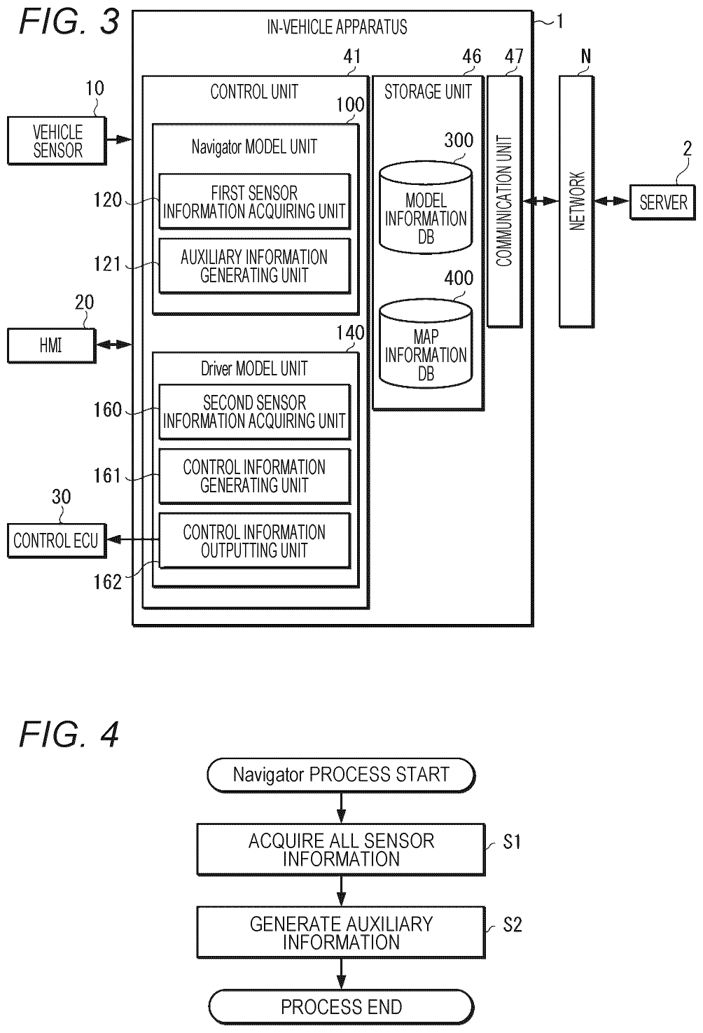

FIG. 3 is a diagram illustrating an example of a functional configuration of the in-vehicle apparatus constituting the information processing system according to an embodiment of the present disclosure.

Here, specifically, the functions of the control unit 41 of the in-vehicle apparatus 1 in an embodiment of the disclosure are roughly divided into the two functions called a Navigator model unit 100 (also referred to herein as Navigator model circuitry) and a Driver model unit 140 (also referred to herein as Driver model circuitry).

The Navigator model unit 100 executes processing related to a large-scale language model (trained model) that conducts integrated cognition and decision-making.

Specifically, the Navigator model unit 100 can perform comprehensive determination on the basis of human language, an input operation, background knowledge, and the like, and provide appropriate instruction information to a Driver model.

On the other hand, the Driver model unit 140 is a high-speed and lightweight arithmetic processing unit or circuitry that performs an arithmetic operation and an inference process on the basis of limited information. Control information is output on the basis of limited sensor information to be described later and auxiliary information output by the Navigator model unit 100.

That is, in automated driving control of the vehicle, it is normally desirable to realize highly accurate recognition and determination with a large amount of information. On the other hand, such high-accuracy information processing takes a long processing time. Therefore, in the present system, the Navigator model unit 100 assists high-accuracy recognition and determination on a medium- to long-term basis, while the Driver model unit 140 that solves the latest operation problem of the vehicle maintains a processing speed. Thus, a processing time that is enough for highly accurate control of a self-driving vehicle as a whole is secured.

Because of this, in the present system, the output cycles in which the Navigator model unit 100 outputs various kinds of information are normally set longer than the output cycles in which the Driver model unit 140 outputs various kinds of information. In the present system, the arithmetic processing and the output processing by the Driver model unit 140 are designed to be lighter than the arithmetic processing and the output processing by the Navigator model unit 100, and are designed to realize control of a vehicle in a time (short time) necessary and sufficient for control of a self-driving vehicle.

As illustrated in FIG. 3, in the control unit 41 of the in-vehicle apparatus 1, various programs and the like are executed to cause the Navigator model unit 100 and the Driver model unit 140 to function.

Also, a model information DB 300 and a map information DB 400 are provided in one region of the storage unit 46 of the in-vehicle apparatus 1.

The model information DB 300 stores a trained model (a program or the like that defines results of learning on which statistical processing has been performed, using the in-vehicle apparatus 1, some other large language model, or the like) for outputting auxiliary information (described later) with respect to input information from various sensors, and a trained model (a program or the like that defines results of learning on which statistical processing has been performed, using the in-vehicle apparatus 1, some other hardware, or the like) for outputting control information (described later) with respect to input information from various sensors.

Meanwhile, the map information DB 400 stores general-purpose map information and the like. The map information is information or the like in which information such as latitudes and longitudes regarding roads, buildings, and the like is displayed in a two-dimensional or three-dimensional format, for example. In the present system, map information stored in the map information DB 400 is used as appropriate in a situation where various kinds of processing described later are necessary.

A functional configuration related to the Navigator model unit 100 is now described.

The Navigator model unit 100 includes a first sensor information acquiring unit 120 (also referred to herein as first acquisition circuitry) and an auxiliary information generating unit 121 (also referred to herein as first output circuitry).

The first sensor information acquiring unit 120 acquires and manages various kinds of information acquired by all the sensors constituting the vehicle sensor 10 (the various kinds of information will be hereinafter referred to as “all the sensor information”).

The auxiliary information generating unit 121 generates information for assisting the Driver model unit 140 in arithmetic processing (this information will be hereinafter referred to as the “auxiliary information”), on the basis of all the sensor information acquired by the first sensor information acquiring unit 120 and the contents of the trained model stored in the model information DB 300.

Here, the auxiliary information is typically information regarding a medium-to long-term action plan or operation instruction of the vehicle, and is information including an instruction regarding an action of the vehicle and a reason for making a determination to issue the instruction.

Specifically, for example, the auxiliary information is instruction information similar to words such as “The color of the traffic light is red. Please stop the vehicle.”, “There is a sharp curve ahead. Please reduce speed gradually.”, “Take a left turn ahead. Please turn on left blinker.”, or “There is an intersection ahead. Please move to the right lane.”. Note that, according to the examples of the auxiliary information, the information “Please stop the vehicle” is an instruction regarding an action of the vehicle, for example, and the information “the color of the traffic light is red” is the reason for the determination to issue the instruction, for example. The auxiliary information includes information of such contents, for example.

In this manner, the present system can more appropriately and efficiently perform operation control with the Driver model unit 140, by incorporating the information regarding a medium- to long-term action plan or operation plan.

The contents of the auxiliary information are now described in greater detail. Specifically, while the vehicle is traveling on a lane of an expressway, for example, information with the contents “Move to the left lane to exit the expressway 1 km ahead” is output as the auxiliary information output by the Navigator model unit 100. The Driver model unit 140 then outputs specific control information, which is “(1) turn on left blinker, (2) change lanes after three seconds from the start of blinking, (3) reduce speed to 90 km/h after the lane change”, for example, as a result of processing based on the auxiliary information and partial sensor information, including information regarding the action that the vehicle should take thereafter. That is, by incorporating the information indicating that the vehicle is to exit the expressway in the auxiliary information in the processing by the Driver model unit 140, it is possible to derive a processing result indicating “(3) reduce speed to 90 km/h after the lane change”, and it is possible to contribute to a more comfortable and safe travel of the occupant.

This auxiliary information includes more information (all the sensor information described later, for example) than the information to be processed by the Driver model unit 140, for example, and information regarding a more accurate medium- to long-term action plan or operation instruction obtained over a calculation time by the Driver model unit 140. On the other hand, the processing by the Driver model unit 140 described later generates a specific control instruction or the like regarding the operation of the vehicle in a shorter period of time than the medium- to long-term action plan or operation plan generated by the Navigator model unit 100, on the basis of limited information (partial sensor information described later, for example) and the generated auxiliary information. By executing such two control processes having different roles in combination, the automated driving control for the vehicle can be performed safely and efficiently.

A functional configuration related to the Driver model unit 140 is now described.

The Driver model unit 140 includes a second sensor information acquiring unit 160 (also referred to herein as second acquisition circuitry), a control information generating unit 161 (also referred to herein as third acquisition circuitry), and a control information outputting unit 162 (also referred to herein as second output circuitry).

The second sensor information acquiring unit 160 acquires and manages some or all of information (hereinafter referred to as the “partial sensor information”) including image information acquired by the camera installed so as to be able to image a view ahead of the vehicle, various kinds of information acquired by the millimeter-wave radar or the ultrasound radar installed so as to be able to acquire information about the view ahead, and various kinds of information acquired by the in-vehicle instrument among the sensors constituting the vehicle sensor 10.

The control information generating unit 161 generates information regarding a specific control instruction for controlling driving of the vehicle (this information will be hereinafter referred to as the “control information”), on the basis of the partial sensor information acquired by the second sensor information acquiring unit 160, the auxiliary information generated by the auxiliary information generating unit 121, and the contents of the trained model stored in the model information DB 300.

Here, the control information is instruction information for each control ECU 30, for example. Specifically, the control information is information for controlling movement of a mobile object, and, in the vehicle in an embodiment of the disclosure, the control information is vehicle speed information, acceleration/deceleration information about the vehicle, information regarding an action plan such as a movement trajectory that the vehicle should follow, information regarding an azimuth direction in which the vehicle should travel, and the like.

Also, the control information may include information regarding an operation instruction to the driver or the like, including an instruction regarding a predicted path of the vehicle and a special action, for example. The predicted path is a predicted future path of the vehicle calculated or planned on the basis of the partial sensor information, for example. Further, the special action is specific instruction information regarding operations such as operations of the left and right blinkers (including blinking of a hazard lamp), sudden deceleration, a shift instruction, and a horn instruction, for example.

Each control ECU 30 can realize appropriate automated driving of the vehicle by performing control on the vehicle on the basis of the control information.

The control information outputting unit 162 provides the control information generated by the control information generating unit 161 to the control ECU 30 and the like of the vehicle system S.

FIG. 4 is a diagram for explaining an example flow of a Navigator process among processes to be executed by the in-vehicle apparatus constituting the information processing system according to an embodiment of the present disclosure.

In step S1, the first sensor information acquiring unit 120 acquires and manages all the sensor information obtained by all the sensors constituting the vehicle sensor 10.

In step S2, the auxiliary information generating unit 121 generates the auxiliary information on the basis of all the sensor information acquired by the first sensor information acquiring unit 120 and the contents of the trained model stored in the model information DB 300. At this point, the Navigator process of the in-vehicle apparatus 1 comes to an end.

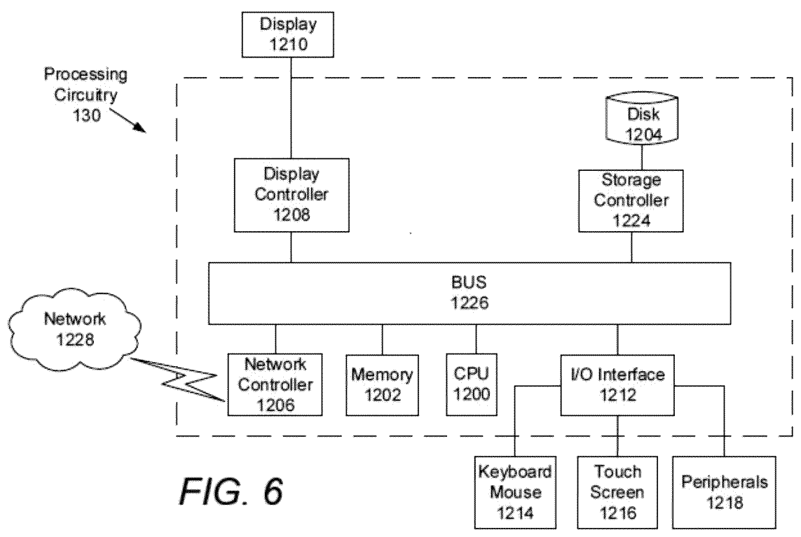

Specifically, Navigator model unit 100 including first sensor information acquiring unit 120 and auxiliary information generating unit 121 may be circuitry to perform steps S1 and S2. More specifically, the circuitry may correspond to the first acquisition circuitry and the first output circuitry, and this circuitry may also be a computer or a quantum computer provided with, for example, a processor, a storage, such as memory, an input system, a display, and a signal I/O interface. The Navigator model unit 100, first sensor information acquiring unit 120, and auxiliary information generating unit 121 including circuitry may be configured by software to perform the steps S1 and S2 described herein. In one embodiment, the Navigator model unit 100, first sensor information acquiring unit 120, and auxiliary information generating unit 121 including circuitry is an Application Specific Integrated Circuit (ASIC) that performs the steps S1 and S2, or a hybrid calculator that includes both a programmable calculator, and an ASIC. In this embodiment, the Navigator model unit 100, first sensor information acquiring unit 120, and auxiliary information generating unit 121 including circuitry is a programmable computer that is configured by software to control individual components of the vehicle system S or in-vehicle apparatus 1. The Navigator model unit 100, first sensor information acquiring unit 120, and auxiliary information generating unit 121 including circuitry allows an operator to input commands to control the vehicle system S or in-vehicle apparatus 1 through an input device such as a keyboard, touch panel, or the like. The Navigator model unit 100, first sensor information acquiring unit 120, and auxiliary information generating unit 121 including circuitry allows display to present the operational state of the vehicle system S or in-vehicle apparatus 1 visually. The storage unit 46 or storage stores control programs. The circuitry including the processor executes the control programs to execute various processes of the vehicle system S or in-vehicle apparatus 1, and controls individual components of the vehicle system S or in-vehicle apparatus 1. Further, the Navigator model unit 100, first sensor information acquiring unit 120, and auxiliary information generating unit 121 may be implemented as the processing circuitry 130, discussed later in reference to FIG. 6.

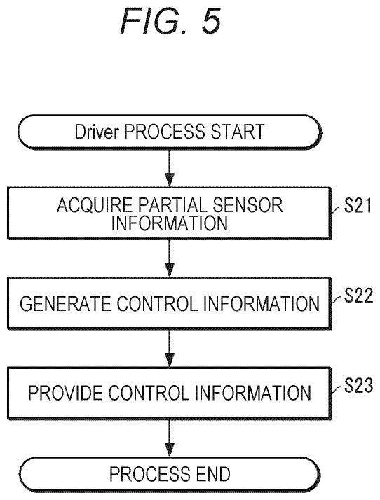

FIG. 5 is a diagram for explaining an example flow of a Driver process among processes to be executed by the in-vehicle apparatus constituting the information processing system according to an embodiment of the present disclosure.

In step S21, the second sensor information acquiring unit 160 acquires and manages some or all of the partial sensor information including the image information acquired by the camera installed so as to be able to image a view ahead of the vehicle, the various kinds of information acquired by the millimeter-wave radar or the ultrasound radar installed so as to be able to acquire information about the view ahead, and the various kinds of information acquired by the in-vehicle instrument among the sensors constituting the vehicle sensor 10.

In step S22, the control information generating unit 161 generates the control information regarding a specific control instruction for controlling driving of the vehicle, on the basis of the partial sensor information acquired by the second sensor information acquiring unit 160, the auxiliary information generated by the auxiliary information generating unit 121, and the contents of the trained model stored in the model information DB 300.

In step S23, the control information outputting unit 162 provides the control information generated by the control information generating unit 161 to the control ECU 30 and the like of the vehicle system S. At this point, the Driver process of the in-vehicle apparatus 1 comes to an end.

Specifically, Driver model unit 140 including second sensor information acquiring unit 160, control information generating unit 161, and control information outputting unit 162 may be circuitry to perform steps S21-S23. More specifically, the circuitry may correspond to the second acquisition circuitry, the third acquisition circuitry, and the second output circuitry and this circuitry may also be a computer or a quantum computer provided with, for example, a processor, a storage, such as memory, an input system, a display, and a signal I/O interface. The Driver model unit 140, second sensor information acquiring unit 160, control information generating unit 161, and control information outputting unit 162 including circuitry may be configured by software to perform the steps S21-S23 described herein. In one embodiment, the Driver model unit 140, second sensor information acquiring unit 160, control information generating unit 161, and control information outputting unit 162 including circuitry is an Application Specific Integrated Circuit (ASIC) that performs the steps S21-S23, or a hybrid calculator that includes both a programmable calculator, and an ASIC. In this embodiment, the Driver model unit 140, second sensor information acquiring unit 160, control information generating unit 161, and control information outputting unit 162 including circuitry is a programmable computer that is configured by software to control individual components of the vehicle system S or in-vehicle apparatus 1. The Driver model unit 140, second sensor information acquiring unit 160, control information generating unit 161, and control information outputting unit 162 including circuitry allows an operator to input commands to control the vehicle system S or in-vehicle apparatus 1 through an input device such as a keyboard, touch panel, or the like. The Driver model unit 140, second sensor information acquiring unit 160, control information generating unit 161, and control information outputting unit 162 including circuitry allows display to present the operational state of the vehicle system S or in-vehicle apparatus 1 visually. The storage unit 46 or storage stores control programs. The circuitry including the processor executes the control programs to execute various processes of the vehicle system S or in-vehicle apparatus 1, and controls individual components of the vehicle system S or in-vehicle apparatus 1. Further, the Driver model unit 140, second sensor information acquiring unit 160, control information generating unit 161, and control information outputting unit 162 may be implemented as the processing circuitry 130, discussed later in reference to FIG. 6.

Although embodiments of the present disclosure have been described, the present disclosure is not limited to the above embodiments, and modifications, improvements, and the like within the scope of achieving the objective of the present disclosure are included in the present disclosure.

### OTHER EMBODIMENTS

In the embodiments described above, the vehicle has been described as, for example, a general-purpose self-driving vehicle, but is not limited to this. Vehicles to which the present system can be applied may include any type of mobile object having any shape or power source, such as an automobile, a truck, a motorcycle, a railroad vehicle, a bicycle, a robot, an automatic guided vehicle (AGV), and a drone.

Furthermore, an information processing apparatus or an information processing system according to the present system does not need to independently function as an information processing apparatus, and may be formed integrally with a vehicle (a mobile object), for example.

Also, in the embodiments described above, the second sensor information acquiring unit 160 has been described as a component to acquire, as the partial sensor information, only the information related to the camera installed to be able to image a view ahead of the vehicle, the millimeter-wave radar or the ultrasound radar installed to be able to acquire information about the front side, and the in-vehicle instrument, but is not limited to this. An administrator or the like of the present system can design which type(s) of sensor information is to be used as the partial sensor information.

Specifically, at a time of backward movement such as a time when the vehicle moves backward, for example, the partial sensor information may include all or some of an image acquired by the camera capable of imaging a view behind, various kinds of information acquired by the millimeter-wave radar or the ultrasound radar installed so as to be capable of acquiring information about the view behind, and images acquired by the cameras capable of capturing images of views on the sides.

Furthermore, the present system may change selection of sensors from which information is to be acquired as the partial sensor information, depending on the situation of the vehicle. Specifically, the present system acquires only information from the front camera as the partial sensor information at normal times, for example, but may acquire images from the left and right cameras or the rear camera (in the direction in which a lane change is to be performed, for example) as the partial sensor information at a time of a lane change or the like. The lane change mentioned herein may include a vehicle operation such as simple lateral movement, a left turn, or a right turn.

Note that the advantage that the Driver model unit 140 of the present system acquires not the sensor information obtained by all the sensors but only the partial sensor information and executes various kinds of processing lies in that the Driver model unit 140 acquires information only from the partial sensor information and performs processing related to the operation of the vehicle, so that processing can be performed at a higher speed than that in a case where the information obtained by all the sensors is acquired and processed.

Although not described in the above embodiments, the trained model used in the Navigator model unit 100 or the Driver model unit 140 may be updated as appropriate before or after generation of various kinds of information.

For example, the in-vehicle apparatus 1 may acquire a newly trained model using the output auxiliary information, control information, or the like, and update the contents of the trained model stored in the model information DB 300. Note that the training method used here may be one of the methods classified into various kinds of deep learning such as deep neural network (DNN), a combination thereof, or the like, for example.

Although explained only briefly in the above embodiments, the information stored in the model information DB 300 has been subjected to a training process beforehand by the in-vehicle apparatus 1, some other hardware, or the like. Specifically, the information stored in the model information DB 300 is model information that has been sufficiently adjusted for applications to automated driving by a method of labeling separately-collected travel images of the vehicle with information regarding control of the vehicle, supplementary information, and the like, in addition to conducting training with a wide range of information including various moving images, text, and natural languages.

Note that the training data and the like that are used for these trainings are not necessarily data acquired by a vehicle to which automated driving is applied, but may be training data or the like generated by some other vehicle or a method such as a simulation.

Further, in the training according to the present system, a general-purpose large language model such as ChatGPT or Bidirectional Encoder Representations from Transformers (BERT) may be used, for example. Note that, in a case where such a large language model or the like is used, various kinds of information acquired regarding movement of the vehicle may be further learned to generate a trained model, for example.

Further, although not described in the above embodiments, the present system may connect only the navigation system mounted on the vehicle and the Navigator model unit 100, and prohibit connection between the navigation system and the Driver model unit 140. As a result, the Driver model unit 140 performs only the arithmetic processing necessary for controlling actions of the vehicle without performing unnecessary arithmetic processing, and thus, a sufficiently high speed can be secured for the arithmetic processing.

Further, although not described in the above embodiments, the control information generating unit 161 of the Driver model unit 140 may have a function of setting a severer constraint regarding the operation (autonomous actions) of the vehicle than that in a case where the auxiliary information has been successfully acquired, when the auxiliary information generated by the auxiliary information generating unit 121 cannot be acquired. For example, the control information generating unit 161 may adjust the automated driving level between 1 and 5, such as restricting the level of automated driving to “automated driving level 1”, at which the driver is requested to hold and monitor the steering wheel, or restricting the level of automated driving to “automated driving level 2”, at which only forward monitoring of the driver is requested, and immediate transfer of steering to the driver is possible.

In this case, when the auxiliary information cannot be acquired, for example, the control information generating unit 161 does not necessarily generate the control information, or may output the control information according to the restriction at the automated driving level as described above.

Furthermore, in the above embodiments, the external environment around the vehicle has been described as an example of the environment of a mobile object. However, the environment of a mobile object is not necessarily limited only to the external environment around the vehicle.

Although not described in the above embodiments, the present system may output the auxiliary information as information in a mode in which outside information is expressed as a vector similar to a natural language, for example. Also, the present system may output the auxiliary information as information in a mode that can be understood by a human as a natural language, for example.

Further, although mentioned only briefly in the above embodiments, the types, the numbers, and the like of the various sensors included in the vehicle sensor 10 can be determined by an administrator or the like of the present system. In the present system, any sensor different from the above-mentioned sensors may be part of the configuration of the vehicle sensor 10, or any unnecessary sensor may be omitted from the configuration of the vehicle sensor 10, for example.

Furthermore, since the number of the various sensors of the vehicle sensor 10 can be freely determined, the present system may install a plurality of cameras, microphones, or the like at any positions in/on the vehicle.

Further, the above-described series of processes can be executed by hardware, or can be executed by software.

In other words, the functional configuration in FIG. 3 and other drawings is merely an example, and is not limited to any particular configuration.

That is, it is sufficient that the information processing system has a function capable of executing the above-described series of processes as a whole, and which functional blocks are to be used to realize this function are not limited to the example illustrated in FIG. 3 and other drawings. Also, the locations of the functional blocks are not limited to those in the example in FIG. 3 and other drawings, and may be located at any positions.

Further, one functional block may be formed only with hardware, may be formed only with software, or may be formed with a combination thereof.

In this regard, FIG. 6 is a block diagram of processing circuitry 130 for performing computer-based operations described herein. FIG. 6 illustrates processing circuitry 130 that may be used to control any computer-based control processes, descriptions or blocks in flowcharts can be understood as representing modules, segments or portions of code which include one or more executable instructions for implementing specific logical functions or steps in the process, and alternate implementations are included within the scope of the exemplary embodiments of the present advancements in which functions can be executed out of order from that shown or discussed, including substantially concurrently or in reverse order, depending upon the functionality involved, as would be understood by those skilled in the art. The various elements, features, and processes described herein may be used independently of one another or may be combined in various ways. All possible combinations and sub-combinations are intended to fall within the scope of this disclosure.

In FIG. 6, the processing circuitry 130 includes a CPU 1200 which performs one or more of the control processes described above/below. The process data and instructions may be stored in memory 1202. These processes and instructions may also be stored on a storage medium disk 1204 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the processing circuitry 130 communicates, such as a server or computer.

Further, the claimed advancements may be provided as a utility application, background daemon, or component of an operating system, or combination thereof, executing in conjunction with CPU 1200 and an operating system such as Microsoft Windows, UNIX, Solaris, LINUX, Apple MAC-OS and other systems known to those skilled in the art.

The hardware elements in order to achieve the processing circuitry 130 may be realized by various circuitry elements. Further, each of the functions of the above described embodiments may be implemented by circuitry, which includes one or more processing circuits. A processing circuit includes a particularly programmed processor, for example, processor (CPU) 1200, as shown in FIG. 6. A processing circuit also includes devices such as an application specific integrated circuit (ASIC) and conventional circuit components arranged to perform the recited functions.

In FIG. 6, the processing circuitry 130 includes a CPU 1200 which performs the processes described above. The processing circuitry 130 may be a general-purpose computer or a particular, special-purpose machine.

Alternatively, or additionally, the CPU 1200 may be implemented on an FPGA, ASIC, PLD or using discrete logic circuits, as one of ordinary skill in the art would recognize. Further, CPU 1200 may be implemented as multiple processors cooperatively working in parallel to perform the instructions of the inventive processes described above.

The processing circuitry 130 in FIG. 6 also includes a network controller 1206, such as an Intel Ethernet PRO network interface card from Intel Corporation of America, for interfacing with network 1228. As can be appreciated, the network 1228 can be a public network, such as the Internet, or a private network such as an LAN or WAN network, or any combination thereof and can also include PSTN or ISDN sub-networks. The network 1228 can also be wired, such as an Ethernet network, or can be wireless such as a cellular network including EDGE, 3G and 4G wireless cellular systems. The wireless network can also be Wi-Fi, Bluetooth, or any other wireless form of communication that is known.

The processing circuitry 130 further includes a display controller 1208, such as a graphics card or graphics adaptor for interfacing with display 1210, such as a monitor. A general purpose I/O interface 1212 interfaces with a keyboard and/or mouse 1214 as well as a touch screen panel 1216 on or separate from display 1210. General purpose I/O interface also connects to a variety of peripherals 1218 including printers and scanners.

The general-purpose storage controller 1224 connects the storage medium disk 1204 with communication bus 1226, which may be an ISA, EISA, VESA, PCI, or similar, for interconnecting all of the components of the processing circuitry 130. A description of the general features and functionality of the display 1210, keyboard and/or mouse 1214, as well as the display controller 1208, storage controller 1224, network controller 1206, sound controller 1220, and general purpose I/O interface 1212 is omitted herein for brevity as these features are known. Further, the above-discussed circuitry including control electronic control circuitry, Navigator model circuitry, Driver model circuitry, first acquisition circuitry, first output circuitry, second acquisition circuitry, third acquisition circuitry, second output circuitry, controller, and communicator may each be implemented individually or in combination as the above-discussed processing circuitry 130.

Also, the number of types of hardware constituting the present system and the users are not limited, and some other hardware and the like may be incorporated.

Further, in a case where the series of processes is executed by software, the program constituting the software is installed into a computer or the like from a network or a recording medium (also referred to herein as a non-transitory computer-readable medium).

Furthermore, the computer may be a computer incorporated in dedicated hardware. Also, the computer may be a computer capable of executing various functions by installing various programs.

Further, the recording medium storing such programs is not necessarily formed with a removable medium (not shown) provided separately from the apparatus main body in order to provide the programs to the user or the like, but may be formed with a recording medium or the like that is incorporated into the apparatus main body beforehand and is then provided to the user.

Further, in the present specification, the term “system” means an overall apparatus including a plurality of devices, a plurality of means, and the like.

Even in a case where these other embodiments are adopted, the functions and effects of the above-described embodiments are exerted. Also, the above-described embodiments and any of the other embodiments can be combined as appropriate, and the other embodiments can be combined with each other as appropriate.

To sum up, the information processing system applied to the present disclosure can take various embodiments in various modes having the following configuration.

The information processing apparatus can be, for example, an information processing apparatus that includes a first system and a second system, in which
the first system includes:
first acquisition circuitry (the first sensor information acquiring unit 120, for example) configured to acquire sensor information that is information regarding an environment of a predetermined mobile object, the information being acquired by sensors installed in the mobile object; and first output circuitry (the auxiliary information generating unit 121, for example) configured to output auxiliary information for assisting determination of control information for controlling an action of the mobile object, on the basis of the sensor information, and
the second system includes:
second acquisition circuitry (the second sensor information acquiring unit 160, for example) configured to acquire partial sensor information from at least one of the sensors installed in the mobile object;
third acquisition circuitry (the control information generating unit 161, for example) configured to acquire the auxiliary information output by the first output circuitry; and
second output circuitry (the control information outputting unit 162, for example) configured to output the control information, using at least part of the partial sensor information or the auxiliary information.

### REFERENCE SIGNS LIST

S Vehicle system
1 In-vehicle apparatus
100 Navigator model unit
120 First sensor information acquiring unit
121 Auxiliary information generating unit
130 Processing Circuity
140 Driver model unit
160 Second sensor information acquiring unit
161 Control information generating unit
162 Control information outputting unit
300 Model information DB
400 Map information DB
10 Vehicle sensor
20 HMI
30 Control ECU
41 Control unit
2 Server
1200 CPU
1202 Memory
1204 Disk
1206 Network Controller
1208 Display Controller
1210 Display
1212 I/O Interface
1214 Keyboard Mouse
1216 Touch Screen
1218 Peripherals
1224 Storage Controller
1226 Bus
1228 Network

1. An information processing apparatus comprising:
a first system and a second system, wherein
the first system includes:
first acquisition circuitry configured to acquire sensor information that is information regarding an environment of a predetermined mobile object, the information being acquired by at least one or more sensors installed in the mobile object; and
first output circuitry configured to output auxiliary information for assisting determination of control information for controlling an action of the mobile object, on a basis of the sensor information,
the second system includes:
second acquisition circuitry configured to acquire partial sensor information from at least one sensor of the one or more sensors installed in the mobile object;
third acquisition circuitry configured to acquire the auxiliary information output by the first output circuitry; and
second output circuitry configured to output the control information, using at least part of the partial sensor information or the auxiliary information.

2. The information processing apparatus according to claim 1, wherein:
the first output circuitry is further configured to output, as the auxiliary information, information including an instruction regarding an action of the mobile object and a reason for determining to issue the instruction.

3. The information processing apparatus according to claim 1, wherein:
an output cycle of the first output circuitry is longer than an output cycle of the second output circuitry.

4. The information processing apparatus according to claim 1, wherein:
the first acquisition circuitry is further configured to acquire the sensor information including information acquired from a light sensor including a camera provided to observe directions including front, rear, leftward, and rightward directions of the mobile object, and a sound collecting device installed at an external portion of the mobile object.

5. The information processing apparatus according to claim 4, wherein:
the sound collecting device installed at the external portion of the mobile object includes a plurality of the sound collecting devices disposed on left and right sides of the mobile object.

6. The information processing apparatus according to claim 1, wherein:
the second acquisition circuitry is further configured to acquire, as the partial sensor information, information acquired by an imaging apparatus capable of imaging a view ahead of the mobile object in a traveling direction.

7. The information processing apparatus according to claim 1, wherein:
in response to an action of moving in a different direction from a direction in which the mobile object is currently traveling is planned, the second acquisition circuitry is further configured to acquire information regarding the different direction as the partial sensor information.

8. The information processing apparatus according to claim 4, wherein:
the first acquisition circuitry is further configured to acquire the sensor information including information acquired from a radar related to millimeter waves or from a sonar related to sonar information.

9. The information processing apparatus according to claim 1, wherein:
the second output circuitry is further configured to output the control information including information regarding a predicted path of the mobile object and a special action in control of the mobile object.

10. The information processing apparatus according to claim 1, wherein:
the first output circuitry further includes trained model managing circuitry, and
the trained model managing circuitry being configured to perform processing for outputting the auxiliary information, using a large language model.

11. The information processing apparatus according to claim 1, wherein:
the auxiliary information includes information regarding an action of the mobile object at a time later than a time of control of the mobile object based on the control information output by the second output circuitry.

12. The information processing apparatus according to claim 1, wherein:
the first system is connected to a navigation system mounted on the mobile object, and the second system is not connected to the navigation system mounted on the mobile object.

13. The information processing apparatus according to claim 1, wherein:
in response to the third acquisition circuitry being unable to acquire the auxiliary information, the mobile object sets a severer restriction on an autonomous action of the mobile object than that in a case where the third acquisition circuitry is able to acquire the auxiliary information.

14. A non-transitory computer-readable medium storing a program that is executed by an information processing apparatus comprising:
a first system and a second system to perform a control process causing
the first system to carry out:
a first acquisition step of acquiring sensor information that is information regarding an environment of a predetermined mobile object, the information being acquired by one or more sensors installed in the mobile object; and
a first output step of outputting auxiliary information for assisting determination of control information for controlling an action of the mobile object, on a basis of the sensor information, and
the second system to carry out:
a second acquisition step of acquiring partial sensor information from at least one sensor of the one or more sensors installed in the mobile object;
a third acquisition step of acquiring the auxiliary information output by the first output step; and
a second output step of outputting the control information, using at least part of the partial sensor information or the auxiliary information.

15. The non-transitory computer-readable medium storing the program according to claim 14, wherein:
the one or more sensors installed in the mobile object including at least one of an imaging apparatus, a light sensor, a radar, a sonar, a laser radar, an acceleration sensor, a global navigation satellite system (GNSS), a sound collecting device, and an in-vehicle instrument.

16. The information processing apparatus according to claim 13, wherein:
the severer restriction on the autonomous action of the mobile object includes adjusting an automated driving level.

17. The information processing apparatus according to claim 1, wherein:
the one or more sensors installed in the mobile object including at least one of an imaging apparatus, a light sensor, a radar, a sonar, a laser radar, an acceleration sensor, a global navigation satellite system (GNSS), a sound collecting device, and an in-vehicle instrument.

18. A vehicle system comprising:
a vehicle sensor; and
an information processing apparatus including:
a first system and a second system, wherein
the first system includes:
first acquisition circuitry configured to acquire sensor information that is information regarding an environment of a predetermined mobile object, the information being acquired by the vehicle sensor installed in the mobile object; and
first output circuitry configured to output auxiliary information for assisting determination of control information for controlling an action of the mobile object, on a basis of the sensor information,
the second system includes:
second acquisition circuitry configured to acquire partial sensor information from the vehicle sensor installed in the mobile object;
third acquisition circuitry configured to acquire the auxiliary information output by the first output circuitry; and
second output circuitry configured to output the control information, using at least part of the partial sensor information or the auxiliary information.

19. The vehicle system according to claim 18, wherein:
the vehicle sensor including at least one of an imaging apparatus, a light sensor, a radar, a sonar, a laser radar, an acceleration sensor, a global navigation satellite system (GNSS), a sound collecting device, and an in-vehicle instrument.

20. The vehicle system according to claim 18, wherein:
in response to the third acquisition circuitry being unable to acquire the auxiliary information, the mobile object sets a severer restriction on an autonomous action of the mobile object than that in a case where the third acquisition circuitry is able to acquire the auxiliary information, and
the severer restriction on the autonomous action of the mobile object includes adjusting an automated driving level.
